(19) United States
(12) Patent Application Publication
(10) Pub. No.: US 2022/0011725 A1
(43) Pub. Date: Jan. 13, 2022

(54) ALARM CLOCK MODULE

(71) Applicant: JONAS CHLADEK, LLC, REDFIELD, IA (US)

(72) Inventor: JONAS CHLADEK, REDFIELD, IA (US)

(21) Appl. No.: 17/305,377

(22) Filed: Jul. 6, 2021

Related U.S. Application Data
(60) Provisional application No. 62/705,607, filed on Jul. 7, 2020.

(51) Int. Cl. G04G 21/04; G04G 13/02; G04G 21/02; G08B 7/06

(52) U.S. Cl. CPC G04G 21/04; G08B 7/06; G04G 21/025; G04G 13/021

(57) ABSTRACT

Upon ending or snoozing an alarm, an alarm clock module automatically engages media controlling devices to accomplish selected tasks. Examples of selected tasks include getting political or financial news, receiving a weather forecast or current traffic conditions, viewing or listen to entertainment, and accessing a planner or a calendar. In other words, the alarm clock module allows users to personalize what content the user would like to access or play while waking up. In use, the user has the ability to skip or adjust the order in which content is accessed or played. The alarm clock module differs from known media controlling devices which interface with virtual assistants because the primary input for the alarm clock module involves turning off or snoozing the alarm.

### CROSS REFERENCE TO RELATED APPLICATIONS

This application claims priority under 35 U.S.C. § 119 to provisional patent application U.S. Ser. No. 62/705,607, filed Jul. 7, 2020. The provisional patent application is herein incorporated by reference in its entirety, including without limitation, the specification, claims, and abstract, as well as any figures, tables, appendices, or drawings thereof.

### FIELD OF THE INVENTION

The present invention relates generally to an apparatus and corresponding method of use in at least the sleep and media industries. More particularly, but not exclusively, the present invention relates to an alarm clock module for engaging media controlling devices.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Sleep is a naturally recurring state of mind and body, characterized by altered consciousness, relatively inhibited sensory activity, inhibition of nearly all voluntary muscles, and reduced interactions with surroundings. Sleep is distinguished from wakefulness by a decreased ability to react to stimuli, but more reactive than coma or disorders of consciousness, sleep displaying very different and active brain patterns.

Sleep occurs in repeating periods, in which the body alternates between two distinct modes: REM sleep and non-REM sleep. Although REM stands for “rapid eye movement,” this mode of sleep has many other aspects, including virtual paralysis of the body. A well-known feature of sleep is the dream, an experience typically recounted in narrative form, which resembles waking life while in progress, but which usually can later be distinguished as fantasy. During sleep, most of the body's systems are in an anabolic state, helping to restore the immune, nervous, skeletal, and muscular systems; these are vital processes that maintain mood, memory, and cognitive function, and play a large role in the function of the endocrine and immune systems. The internal circadian clock promotes sleep daily at night. The diverse purposes and mechanisms of sleep are the subject of substantial ongoing research.

Awakening can mean the end of sleep, or simply a moment to survey the environment and readjust body position before falling back asleep. Sleepers typically awaken soon after the end of a REM phase or sometimes in the middle of REM. Internal circadian indicators, along with successful reduction of homeostatic sleep need, typically bring about awakening and the end of the sleep cycle. Awakening involves heightened electrical activation in the brain, beginning with the thalamus and spreading throughout the cortex.

Today, many humans wake up with an alarm clock. Many sleep quite differently on workdays versus days off, a pattern which can lead to chronic circadian desynchronization. Many people regularly look at television and other screens before going to bed, a factor which may exacerbate disruption of the circadian cycle. Sleep stage at awakening is an important factor in amplifying sleep inertia.

Some models offer dual alarm for awakening at different times and “snooze,” usually a large button on the top that silences the alarm and sets it to resume sounding a few minutes later. Frequent use of the “snooze” button without actually waking up can interfere with the brain's natural waking up process.

Newer clock radios are available with other music sources such as iPod, iPhone, and/or audio CD. When the alarm is triggered, it can play a set radio station or the music from a selected music source to awaken the sleeper. Some models come with a dock for iPod/iPhone that also charges the device while it is docked. They can play AM/FM radio, iPod/iPhone or CD like a typical music player as well (without being triggered by the alarm function). A few popular models offer “nature sounds” like rain, forest, wind, sea, waterfall, etc., in place of the buzzer.

However, standard alarm clocks and “alarm clock” software applications (typically mobile applications) are rudimentary in that they only consist of a series of alarms that can be scheduled to alert the user as a way to wake them from sleep or notify them of a current time. These applications consist primarily of a set sound or recording that plays until the user “snoozes” or “ends” the alarm. Thereafter, these alarms do nothing to motivate a user to begin their day.

Thus, there exists a need in the art for an alarm clock module which, after being woken up, automatically motivates people to accomplish tasks towards the start of their day without further input from the user.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, or advantage of the present invention to improve on or overcome the deficiencies in the art.

It is still yet a further object, feature, or advantage of the present invention to provide an alarm clock module that allows user to customize an order in which content is automatically accessed or played upon waking up.

It is still yet a further object, feature, or advantage of the present invention to provide an alarm clock module that allows user to skip or loop content or adjust the order in which content is automatically accessed or played when used.

It is still yet a further object, feature, or advantage of the present invention to provide an alarm clock module that may be used in a wide variety of applications. For example, the alarm clock module can form part of an alarm clock or the alarm clock module can be downloaded and executed by a computer processing unit of a mobile phone.

It is still yet a further object, feature, or advantage of the present invention to provide a safe, secure, and durable alarm clock module. For example, the alarm clock module will, preferably, (1) restrict third parties from accessing user specific information; (2) protect against viruses, worms, trojans, bots, other types of malware, and phishing or other methods of stealing personal information; (3) use as little power as necessary; and (4) interfere with other software applications, modules, or media controlling devices as little as possible so that functions of the same may be performed as usual.

It is still yet a further object, feature, or advantage of the present invention to provide an alarm clock module that includes a graphical user interface which is aesthetically pleasing.

It is still yet a further object, feature, or advantage of the present invention to practice methods which facilitate use, manufacture, assembly, and repair of the alarm clock module accomplishing some or all of the previously stated objectives.

It is still yet a further object, feature, or advantage of the present invention to incorporate the alarm clock module into a system, e.g., an alarm clock, a mobile phone, a gaming console, a household appliance etc., accomplishing some or all of the previously stated objectives.

The previous list of objects, features, or advantages of the present invention are not exhaustive and do not limit the overall disclosure. Likewise, the following list of aspects or embodiments do not limit the overall disclosure. It is contemplated that any of the objects, features, advantages, aspects, or embodiments disclosed herein can be integrated with one another, either in full or in part, as would be understood from reading the present disclosure.

According to some aspects of the present disclosure, a computer implemented method for engaging media with an alarm clock module comprises connecting the alarm clock module to a network; upon turning off or snoozing the alarm clock module, automatically engaging media with the alarm clock module by communicating with at least one non-transitory computer readable medium also connected to the network; and subsequently performing a task with the non-transitory computer readable medium.

According to some additional aspects of the present disclosure, the alarm clock module is tangibly embodied within an alarm clock or the alarm clock module is tangibly embodied within another media controlling device.

According to some additional aspects of the present disclosure, the task is selected from the group comprising getting local or global political news, getting financial news, receiving a weather forecast, receiving current or anticipated traffic conditions, viewing or listening to entertainment, accessing a planner or a calendar, advertising a good or a service to a user, and any combination thereof.

According to some additional aspects of the present disclosure, the method further comprises setting an alarm in connection with a sequence of media to be played upon the turning off or the snoozing of the alarm clock module.

According to some additional aspects of the present disclosure, a sequence of media to be played upon the turning off or the snoozing of the alarm clock module is determined by how the alarm clock module is turned off or snoozed.

According to some additional aspects of the present disclosure, the method further comprises using an audio notification and/or a visual notification to begin an alarm.

According to some additional aspects of the present disclosure, the method further comprises allowing for a user to skip, loop, or adjust media being played after the turning off or the snoozing of the alarm clock module.

According to some additional aspects of the present disclosure, the method further comprises monitoring sleep of a user with one or more sensors.

According to some additional aspects of the present disclosure, a time in which the user is woken up or a sequence of media to be played upon the turning off or the snoozing of the alarm clock module is determined upon the data collected by the one or more sensors.

According to some additional aspects of the present disclosure, the method further comprises recommending sleep related options to the user based upon the data collected by the one or more sensors.

According to some additional aspects of the present disclosure, the method further comprises tracking time with the alarm clock module by manually inputting a set time and subsequently tracking time elapsed from the set time and/or syncing the time with an external clock.

According to some additional aspects of the present disclosure, the method further comprises allowing a user to designate whether the alarm clock module, the non-transitory computer readable medium, or another non-transitory computer readable medium acts as the primary controlling device.

According to some additional aspects of the present disclosure, the method further comprises storing and encrypting data relating to sleep or wake preferences, personal identifying information, a financial accounting, and/or media preferences associated with a user on a database and allowing the user to view and/or alter the data.

According to some other aspects of the present disclosure, an alarm clock comprises one or more means to connect to a network; instruct speakers or a display to begin an alarm; automatically engage media upon turning off or snoozing the alarm; and perform a task or instruct a non-transitory computer readable medium to perform a task.

According to some additional aspects of the present disclosure, the alarm clock further comprises a sensor for sensing at least one characteristic related to a user's sleep.

According to some additional aspects of the present disclosure, the alarm clock further comprises a central processing unit and a memory with an operating system and a compiler located thereon.

According to some additional aspects of the present disclosure, the alarm clock further comprises an alarm clock module, a sleep module, and/or a media module, each module forming part of a software application executable by the central processing unit in connection with the operating system and the compiler.

According to some additional aspects of the present disclosure, the alarm clock further comprises a user interface having input and/or output devices for delivering an input to the alarm clock.

These and/or other objects, features, advantages, aspects, and/or embodiments will become apparent to those skilled in the art after reviewing the following brief and detailed descriptions of the drawings.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 shows a diagram illustrating an alarm clock system for engaging media.

FIG. 2 shows a diagram illustrating an exemplary hardware environment for practicing the present invention.

FIG. 3 shows a diagram illustrating exemplary hardware elements of an alarm clock module.

FIG. 4 shows a diagram illustrating exemplary functions of and/or steps carried out by the alarm clock module.

FIG. 5 shows a diagram illustrating exemplary functions of and/or steps carried out by a sleep module.

FIG. 6 shows a diagram illustrating exemplary functions of and/or steps carried out by a media module.

FIG. 7 shows a diagram illustrating exemplary functions of a communications module.

FIG. 8 displays aspects of a graphical user interface that allows a user to sign in to a media controlling software application with alarm clock functionality.

FIG. 9 displays aspects of an alarm clock module for the media controlling software application referenced in connection with FIG. 8, said alarm module including various widgets related to the alarm.

FIG. 10 displays aspects of a clock module for the media controlling software application referenced in connection with FIG. 8, said clock module including various widgets relating to a sleep schedule and/or the tracking of time.

FIG. 11 displays aspects of a media module for the media controlling software application referenced in connection with FIG. 8, said media module including various widgets relating to the radio.

FIG. 12 displays aspects of a media module for the media controlling software application referenced in connection with FIG. 8, said media module including various widgets relating to the news.

FIG. 13 displays aspects of a feedback function that allows the user to provide feedback to the provider of the media controlling software application referenced in connection with FIG. 8.

An artisan of ordinary skill need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

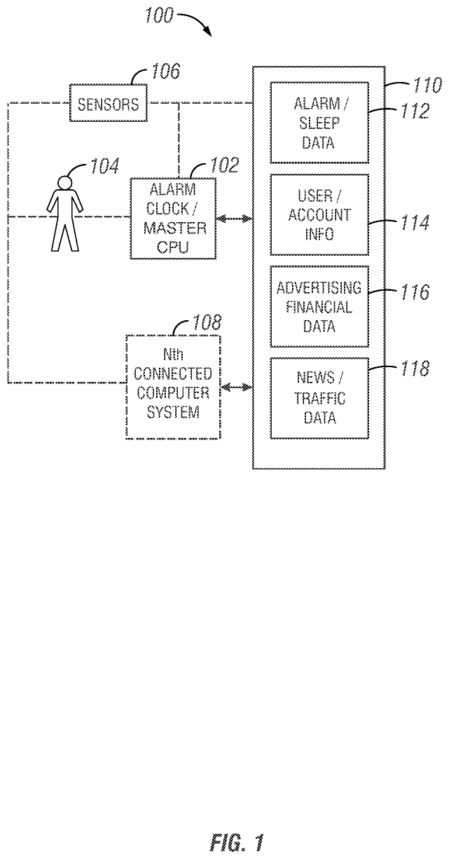

FIG. 1 shows an alarm clock system for engaging media 100 which comprises a number of non-transitory computer readable media, including at least an alarm clock 102. A user 104 may use the alarm clock 102 in connection with automatic sensors 106 and/or to engage a number of media controlling devices 108.

The alarm clock 102 can be a standalone device or can form part of a phone, gaming console, tablet, other computing device, or even a software application usable with a computing device such as a web browser. The alarm clock 102 acts as the primary means for which the functions and/or steps of the present disclosure may be practiced by person(s) considered to be the user 104. Accordingly, the user 104 is the one who sets the alarm of the alarm clock 102, sleeps, is woken up by the alarm, turns off the alarm, and begins their day by interacting with media broadcasted by the media controlling devices 108.

Sensors 106 of the alarm clock system 100 can be installed in a permanent physical location, such as in a bedroom, or on a computer readable medium such as the alarm clock 102, other media controlling device 108, or other apparatus (e.g., finger clip and can provide various types of information to an intelligent control. The sensors 106 sense one or more characteristics of an object. For example, the sensors 106 could monitor sleep of the user 104 and could thus comprise heart rate sensors, breathing (airflow) sensors, temperature sensors, audio sensors (for monitoring vocal tone, pitch, and volume), pressure sensors, timers, motion detectors, gyroscopes, and the like.

In some embodiments, a satellite-based radio-navigation system such as the global positioning system (“GPS”) is used. GPS is owned by the United States and uses satellites to provide geolocation information to a GPS receiver (another type of sensor 106) included with the device on which the alarm clock module 132 (described in more detail below) operates. GPS, and other satellite-based radio-navigation systems, can be used for location positioning, navigation, tracking, and mapping. For example, information from the GPS receiver could be processed along with traffic data to estimate an estimated travel time from a current geographic location to a destination geographic location.

The alarm clock 102 and/or or other non-transitory computer readable media 108 have access to database(s) 110 which store alarm/sleep data 112, user/account information 114, advertising/financial data 116, news/traffic data 118, and/or other types of data. The database 110 is a structured set of data typically held in a computer and is preferably one that is accessible in various ways. The database 110, as well as data and information contained therein, need not reside in a single physical or electronic location. For example, the database 110 may reside, at least in part, on a local storage device, in an external hard drive, on a database server connected to a network, on a cloud-based storage system, in a distributed ledger (such as those commonly used with blockchain technology), and/or the like.

Stored data may be updated periodically, in real time, or in response to an input from the user 104. Some types of data may be accessible by the user 104, while other types of data may be restricted or partially restricted (e.g., behind a paywall) from the view of the user 104. For example, the user 104 may have total access to both alarm/sleep data 112 and user/account information 114 relating to their own account. In another example, news and/or traffic data 118 may be controlled or updated by corporate news entities and may not be accessible to a user 104 unless the user 104 pays for these services. In yet another example, advertisers may have the ability to solicit ads to users 104 of software practicing the present invention and information relating to how much advertisers paid to solicit these advertisements may be hidden from the view of the user 104.

The alarm clock 102 and/or other non-transitory computer readable media 108 are each typically powered by a power supply. Each power supply outputs a particular voltage to a device, component, or set of components of a device. One power supply may power more than one device, component, or set of components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

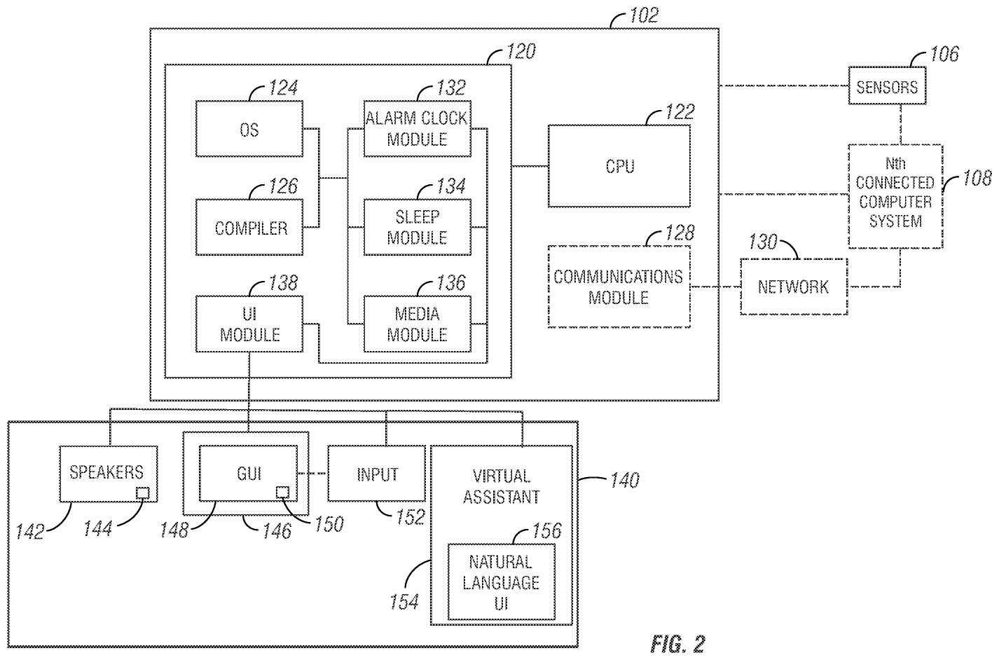

FIG. 2 shows an exemplary alarm clock 102 that could be used to implement selected elements of the present invention, including memory 120 and a user interface (“UI”) 140. The alarm clock 102 according to the aspects of the present disclosure may also include components such as an intelligent control and communication components. Examples of such intelligent control units may be a central processing unit 122 alone or in tablets, phones, handheld devices, laptops, user displays, or generally any other computing device capable of allowing input, providing options, and showing output of electronic functions. Still further examples include a microprocessor, a microcontroller, or another suitable programmable device and a memory. The controller also can include other components and can be implemented partially or entirely on a semiconductor (e.g., a field-programmable gate array (“FPGA”)) chip, such as a chip developed through a register transfer level (“RTL”) design process.

The memory 120 includes, in some embodiments, a program storage area and a data storage area. The program storage area and the data storage area can include combinations of different types of memory, such as read-only memory (“ROM”, an example of non-volatile memory, meaning it does not lose data when it is not connected to a power source) or random access memory (“RAM”, an example of volatile memory, meaning it will lose its data when not connected to a power source). Some additional examples of volatile memory include static RAM (“SRAM”), dynamic RAM (“DRAM”), synchronous DRAM (“SDRAM”), etc. Additional examples of non-volatile memory include electrically erasable programmable read only memory (“EEPROM”), flash memory, a hard disk, an SD card, etc. In some embodiments, the central processing unit 122, such as a processor, a microprocessor, a microcontroller, or an arithmetic logic unit (“ALU”) is connected to the memory 120 and executes software instructions that are capable of being stored in a RAM of the memory (e.g., during execution), a ROM of the memory (e.g., on a generally permanent basis), or another non-transitory computer readable medium such as another memory or a disc.

Generally, the alarm clock 102 operates under control of an operating system 124 stored in the memory 120. The alarm clock 102 also implements a compiler 126 which allows a software application written in a programming language such as COBOL, C++, FORTRAN, or any other known programming language to be translated into code readable by the central processing unit 122. After completion, the software application accesses and manipulates data stored in the memory 120 of the alarm clock 102 using the relationships and logic that was generated using the compiler 126.

In one embodiment, instructions implementing the operating system 124, a software application, and the compiler 126 are tangibly embodied in the alarm clock 102, which could include one or more fixed or removable data storage devices, such as a zip drive, floppy disc drive, hard drive, CD-ROM drive, tape drive, etc. Furthermore, the operating system 124 and the software application are comprised of instructions which, when read and executed by the alarm clock 102, causes the alarm clock 102 to perform the steps necessary to implement and/or use the present invention. A software application and/or operating instructions may also be tangibly embodied in memory 120 and/or a communications module 128, thereby making the software application a product or article of manufacture according to the present invention.

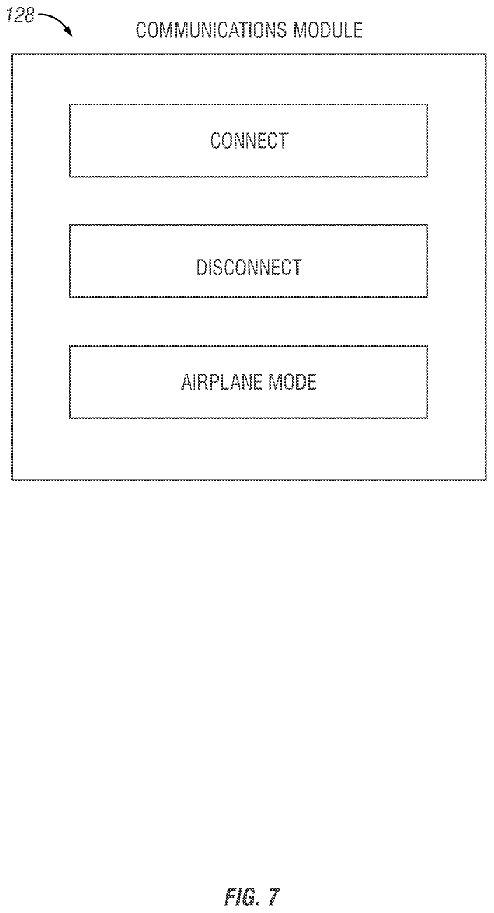

The communications module 128 (discussed in more detail with reference to FIG. 7) can comprise data communication devices to allow the alarm clock 102 to connect to a network 130. The network, for example, may also be connected to the Internet, the sensors 106, other media controlling devices 108, and/or the database 110.

In some embodiments, the network 130 is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communications protocols, such as Wi-Fi, Bluetooth, ZigBee, near field communication (“NFC”), etc., although other types of networks are possible and are contemplated herein. The network 130 typically allows communication between the communications module 128 and a central location during moments of low-quality connections. Communications through the network 130 can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

In some embodiments, the alarm clock 102 could include one or more communications ports such as Ethernet, serial advanced technology attachment (“SATA”), universal serial bus (“USB”), or integrated drive electronics (“IDE”), for transferring, receiving, or storing data.

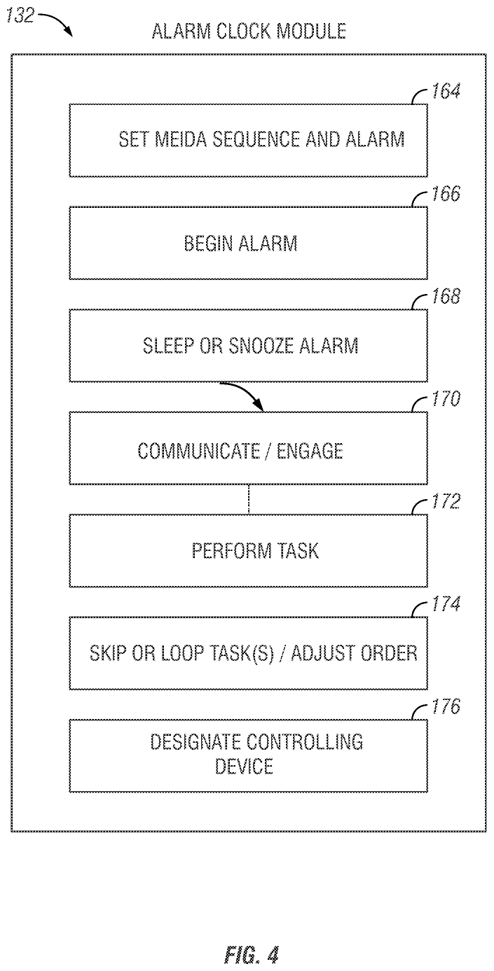

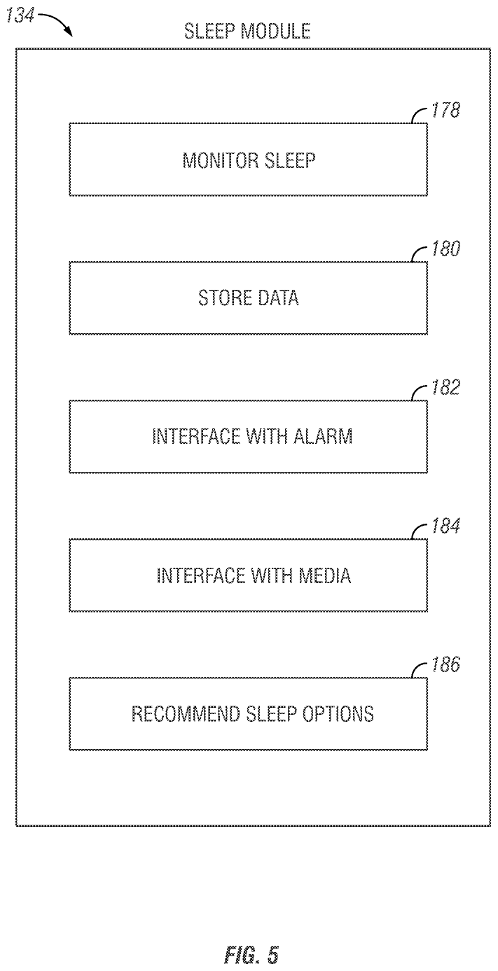

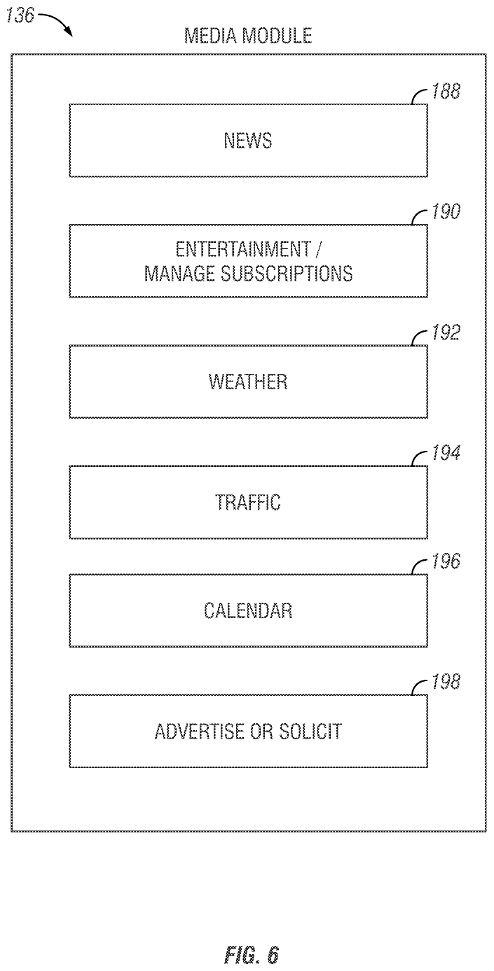

In a preferred embodiment, the program storage area and/or data storage areas comprise an alarm clock module 132 (discussed in more detail with reference to FIG. 4), a sleep module 134 (discussed in more detail with reference to FIG. 5), a media module 136 (discussed in more detail with reference to FIG. 6), and a user-interface module 138.

The alarm clock 102 interfaces with the user 104 to accept input(s) and commands through at least part of the user interface 140 and to present results through the user interface module 138. Although the user interface module 138 is depicted as a separate module, the instructions performing the user interface functions can be resident or distributed in the operating system 124, another software application, or module. Alternatively, the instructions can be implemented with special purpose memory and processors.

The user interface 140 is how the user interacts with the alarm clock 102. The user interface 140 could be a digital interface, a command-line interface, a graphical user interface (“GUI”) 148, or any other way a user can interact with a machine. For example, in a preferred embodiment, the user interface 140 comprises speakers 142, a display 146, and one or more means for receiving an input 152 (especially an input for turning off or snoozing an alarm) from the user 104. The speakers 142 can transmit audio, such as an audio notification 144, in response to instructions received from the operating system 124, the alarm clock module 132, the sleep module 134, the media module 136, and/or the user interface module 138. Non-limiting examples of the audio notification 144 include a chime, music, a voice message, an alert, or the like.

The display 146 typically comprises an electronic screen which projects a graphical user interface 148 to the user 104. More particularly, the display could be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The graphical user interface 148 may employ visual notifications 150 in response to instructions received from the operating system 124, the alarm clock module 132, the sleep module 134, the media module 136, and/or the user interface module 138. Non-limiting examples of the visual notification 150 include an icon, image, a video message, an alert, or the like.

The means for receiving an input 152 can comprise a combination of digital and analog input and/or output devices or any other type of user interface input/output device required to achieve a desired level of control and monitoring for a device. Examples of input and/or output devices include computer mice, keyboards, touchscreens, knobs, dials, switches, buttons, etc. Input(s) 152 received from the user interface 140 can then be sent to a microcontroller to control operational aspects of a device.

In some embodiments, the operating system 124, user interface module 138, and/or user interface 140 can be included with a virtual assistant 154 (e.g., such as those virtual assistants commonly known to the public as Alexa, Cortana, Siri, Bixby, Google Assistant, etc.) which comprises a natural-language user interface 156. The virtual assistant 154 is capable of using voice queries to ask and answer questions, thereby allowing allows for a voice of the user 104 to act as an input 152 to the alarm clock 102. The virtual assistant's ability to speak to the user 104 may help facilitate giving directions, prompt the user to give more specific information and/or instructions to the alarm clock 102, and reduce the time it takes to provide more complicated input(s) 152.

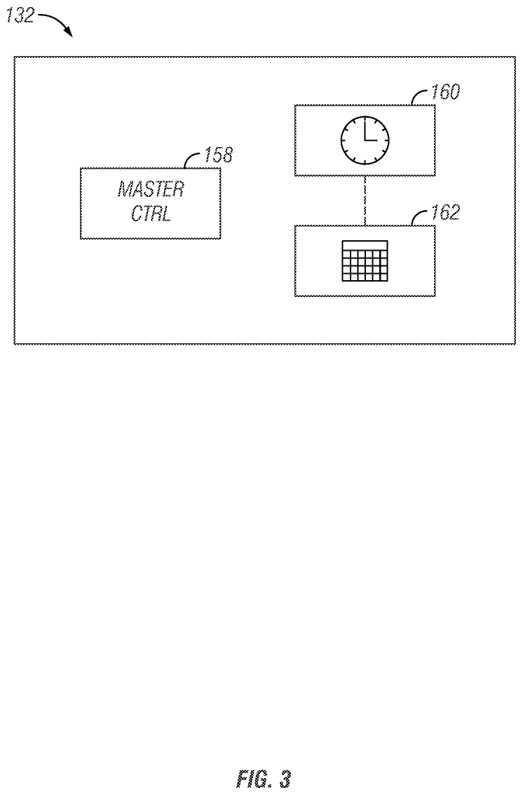

As shown in FIG. 3, the alarm clock module 132 can comprise several sub-modules which facilitate performing alarm clock module functions and/or steps. Yet, it is to be appreciated that while the modules shown in FIG. 3 can be sub-modules of the alarm clock module 132, they are not necessarily limited to being in such a configuration, and configurations will exist where one or more of these sub-modules exist as stand-alone modules stored on the memory 120 or in another location.

Referring back to the embodiment shown, a designation module 158 designates (e.g., 176) which device is to act as the master control device. In at least one embodiment, the master control device is the alarm clock itself 102. In at least one other embodiment, the master control device can be another non-transitory computer readable medium capable of instructing the alarm clock 102 to turn off after sounding an alarm.

Next, the alarm clock module 132 includes a clock module 160 which has a means of tracking time. For example, the time associated with the clock module 160 may be manually set and the clock may have the ability to update the time by “counting” as time progresses. In order to track time accurately, the aforementioned exemplary means for tracking time typically requires the clock module 160 be powered at all times, similar to old clocks included with an oven or a microwave. In another example, the clock module 160 works in connection with the communications module 128 to sync the time stored and/or displayed on the alarm clock 102 with another clock which independently tracks the time, such as one of the many atomic clocks controlled by United States government at the United States Naval Observatory. In this way, if the device upon which the clock module 160 operates loses power, the clock will still be accurate once the device is again powered up and establishes a connection to the Internet. In yet another example, the clock module 160 may employ a combination of the two aforementioned exemplary means for tracking time in which one of the means will be manually or automatically selected and take precedence over the other means for tracking time. Finally, it is to be appreciated that the means for tracking time of the clock module 160 may be used in connection with a GPS receiver or other sensor for determining a geographical location so that the time is accurately reflected irrespective of the user's physical location throughout the world.

Additionally, the embodiment shows the alarm clock module 132 includes a digital calendar module 162 which allows the user 104 to track events and tasks on a daily, weekly, monthly, etc. basis. Alternatively, the calendar module 162 could simply work in connection with the communications module 128 to sync the calendar stored and/or displayed on the alarm clock 102 with another calendar unique to the user (e.g., the calendar tied to the user's Microsoft Outlook® account).

As shown in FIG. 4, the alarm clock module 132 is capable of performing alarm clock module functions and/or steps.

A user 104 will first set 164 the sequence of media to engaged by the media module 136 (discussed in more detail with reference to FIG. 6) and an alarm. Alternatively, the alarm could also be set 164, at least in part, by the calendar module 162. For example, the alarm could be set to wake the user up one hour before their first event of the day. This type of “preemptive alarm” could serve as the default, everyday alarm or could only be utilized for certain days of the week (e.g., any one of the seven days of the week, weekdays, weekends, MWF, TTh, or some combination thereof). Alarms may be set 164 well in advance of the day(s) in which they are to be used or may simply be set for the very next day, as is common with traditional alarm clocks. In some embodiments, the calendar module 162 will allow users to schedule their day by booking and placing orders for food, travel, etc.

Setting the sequence of media to be played may occur manually before the user goes to sleep, may be controlled by a third party, may be determined based on the quality of the user's sleep in connection with biometric sensors 106, or even depend on how the user snoozes or shuts off the alarm clock 102. For example, in order to shut off the alarm, it may be required that the user input one of a select few 4-digit codes into the alarm clock 102, especially where the alarm clock is included with a mobile phone. Accordingly, users 104 sharing a single alarm clock may be able to shut off the alarm clock 102 with their own personal 4-digit code which plays their own personalized media sequence. Alternatively, a single user may have many 4-digit codes so that he or she can quickly decide in the morning which media sequence to play that day. For example, a user 104 may choose to input a code that ends in a 1 (e.g., 1231) to access their “Monday” playlist, which may be heavily news driven so that the user 104 can catch up on events that happened over the weekend so that they remain “in the loop” at work. That same user 104 could have a 4-digit code that ends in a 2 (e.g., 1232) to access their “Tuesday” playlist which is calendar because the user 104 typically has a lot of meetings on Tuesday, or perhaps because there is some significant recurring event that happens at work on Tuesdays. That same user 104 could have a 4-digit code that ends in a 5 (e.g., 1235) to access their “Friday” playlist which is heavily weather related so that the user may plan their weekend activities more easily. As one of ordinary skill in the art would be able to recognize, the possibilities are only limited by the number of ways in which the alarm may be turned off or snoozed.

Setting 164 the alarm may also entail determining what type of alarm is used to wake up the user 104. For example, in the same way a user 104 selects a ringtone to be heard when their phone rings, the user 104 may determine what type of audio and/or visual notification 144/150 may be used in connection with waking up. The alarm clock 102 have a radio receiver that can be set to start playing the radio at specified times. Music of the user's choice may also be played as the alarm. Multiple alarms may be set 164 at once. The volume of the alarm may progress as time elapses and the user 104 does not shut off the alarm. The alarm may even turn off if the user does not respond to the alarm within a certain amount of time (e.g. 15 minutes). This helps prevent the alarm clock 102 from using too much battery or from annoying those who did not set the alarm where, for example, the user 104 sets 164 the alarm, wakes up early, forgets to disengage the alarm, and leaves the location of the alarm clock 102, such as the user's home.

If, for example, an alarm is set 164 for 6 a.m. the next day, the clock module 160 will track the time until it is finally time for the user to wake up (i.e., 6 a.m. the next day). The alarm will begin 166, and the selected audio or visual notification 144/150 will be heard or displayed until the user snoozes or shuts off 168 the alarm.

Upon turning off or snoozing the alarm clock 102, the alarm clock module 132 will automatically, in connection with the media module 136 (discussed in more detail with reference to FIG. 6), communicate 170 with at least one media controlling device 108 connected to the network 130 to perform 172 a selected task. Alternatively, the alarm clock module 132 and/or media module 136 may perform 172 the task itself. Exemplary tasks include getting local or global political news, getting financial news (e.g., updates on specific stocks or the stock market as a whole), receiving a weather forecast, receiving current or anticipated traffic conditions, viewing or listening to entertainment; accessing a planner or a calendar, or the like.

Tasks, such as those in a sequence of media to be played, may be manually or automatically adjusted, looped, or skipped by the user while the media is played or just prior to certain tasks being performed. For example, perhaps the task to be performed is to access the user's calendar; if computer upon which the alarm clock module 132 is located determines the user 104 has no events that day on their calendar, this task could be automatically skipped. Alternatively, the user 104 could themselves determine that they are busy and so they could adjust the order in which their tasks are performed so that music is played at the end of the sequence, thereby expediting the process of getting ready in the morning.

As shown in FIG. 5, the sleep module 134 is capable of performing communications module functions and/or steps. For example, the sleep module 134 can work in connection with the sensors 106 to monitor 178 sleep. Sleep data 112 collected by the sensors 106 can be stored 180 by the database 110 or elsewhere and can be used to interface 182 with the alarm module 132 and/or interface 184 with the media module 136. For example, a time in which the user is woken up or a sequence of media to be played upon the turning off or the snoozing of the alarm clock module is determined upon sleep data 112 collected by the sensors 106. In another example, upon monitoring 178 sleep of the user 104 with the sensors 106, the sleep module 134 may recommend 186 the user go to bed at an earlier time, use a device that facilitates sleeping (such as a sleep apnea machine), consult a doctor, another sleep option intended to help the user 104 have better sleep, or the like.

As shown in FIG. 6, the media module 136 is capable of performing sleep module functions and/or steps. More particularly, the media module 136 can get local or global political and/or financial news 188, view or listen to entertainment 190, receive a weather forecast 192 or traffic conditions 194, access a planner or a calendar 196. The media module 136 also allows for a good or a service to be advertised 198 to the user 104. This can mean that a software application that comprises a combination of the alarm clock module 132, the sleep module 134, and the media module 136 can be made available to the user 104 at a substantial discount to the user 104 (or perhaps even at no charge). Preferably, the media module 136 will also allow the user 104 to manage or pay for subscriptions to outside entities (such as news corporations or music conglomerates) which grant access to some of their content in connection to use of the alarm clock 102.

As shown in FIG. 7, the communications module 128 is capable of performing communications module functions and/or steps. Namely the communications module 128 can provide the ability to connect or disconnect to the network 130. Additionally, the communications module 128 can provide the ability to allow the non-transitory computer readable medium to engage airplane mode, which may or may not disable a GPS receiver associated therewith.

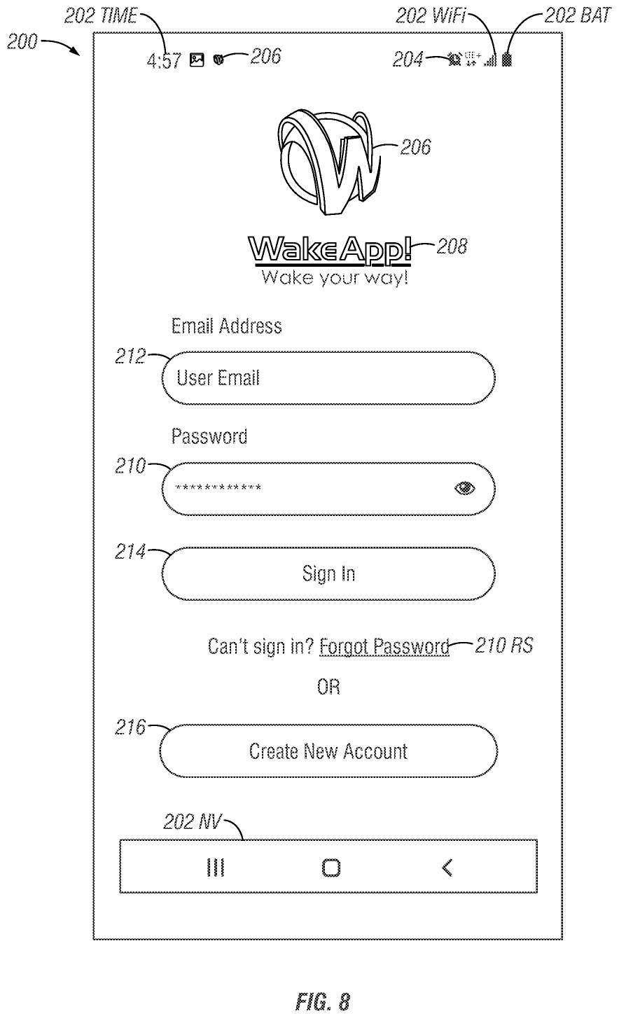

FIGS. 8-13 show various mobile phone screenshots 200 that exemplify one potential embodiment of the graphical user interface 148. Common to each graphical user interface 148 throughout FIGS. 8-13 are universal functions and/or indicators (collectively 202). The functions and/or indicators 202 can be seen in the upper left-hand corner, upper right-hand corner, and lower edge of FIG. 8. Such functions and/or indicators can be aspects of the mobile device's native interface. The functions and/or indicators 202 can relate to other features that are incorporated from other apps later installed on the mobile device. The mobile device's native navigation features 202NV can appear in some standard location, such as at the bottom of the screen. Other examples of the features and/or indicators 202 can include the mobile device's native time telling indicator 202TIM, remaining battery power 202BAT, and wireless connectivity 202Wi-Fi (e.g., any means through which the mobile application can access the Internet with its communications module 128 through network 130).

One particularly beneficial indicator that can be included is the alarm indicator 204. The alarm indicator 204 in some embodiments will be the same indicator that would exist if the mobile phone's ordinary alarm feature was set using the mobile phone's native alarm application. Alternatively, an entirely different logo 206, such as an alarm clock of a different color (e.g., yellow), or the styled “W” logo shown in FIG. 8, can be used to indicate the alarm set is actually through a s software application provided in accordance with the technologies described herein. The alternative logo 206 can exist in combination with and/or in lieu of the native alarm indicator 204. Such an alternative or styled logo 206 can be used to indicate specifically that the media controlling software application is running on the non-transitory computer readable medium 102, 108 upon which it has been installed and/or that an alarm has been set. Other times, the styled logo 206 can simply be used to promote the software application provider's brand and/or advertisements. Slogans 208 and/or other advertisements can also be included. The indicators 202, alarm indicator 204, alternative or styled logo 206, and/or slogans can be placed in any other suitable location to achieve their intended function, but will preferably be placed in an intuitive manner and/or grouped such that like functions are near one another.

According to some aspects of the invention, utilization of the software application can be restricted to only those persons having appropriate access to same. Thus, a password 210, sometimes called a passcode, can be utilized so as to prevent unauthorized users from viewing, using, and/or editing aspects of the alarm, software application, and the like. The password 210 is secret data, typically an alphanumeric string of characters which can be, but is not required to be, combined with other symbols commonly found on a computer keyboard. The password 210 can be used to confirm the identity of the user 104. When the user 104 successfully demonstrates knowledge of the password 210 to the verifier through an established authentication protocol, the verifier is able to infer the identity of the user 104 and access to any features behind the password are usable by and/or revealed to the user 104.

An example of such use of a password 210 can be seen in FIG. 8. FIG. 8 shows a touch-screen based sign-in screen. To gain access to the mobile app, the user 104 can input their username 212 (e.g., an email address, self-selected name, etc.) and password 210, and then hit a button 214 to sign in. Aspects of the username 212 and password 210 can be initially selected and/or continuously kept by the provider of the software application or a third party. Said aspects can also be kept with user/account information 114. It is to be appreciated that where passwords 210 are utilized, usernames 212 are not necessarily required. There can exist embodiments where the account may simply be associated with the device itself (i.e. one account per device). The password 210 can comprise a 4, 6, or 8 digit personal identification number (“PIN”).

The user 104 can also be allowed to “register/create a new account” 216 with a new username and password and/or the ability to engage a self-service password reset (“SSPR”) 210RS. An SSPR is any process or technology that allows users 104 who have either forgotten their password or triggered an intruder lockout to authenticate with an alternate factor. This allows the user 104 to repair their own problem, without calling a help desk. Security questions may be utilized is a means for verifying identity during the SSPR 210RS. Additionally, password managers with “remember me” features can be used. Such password managers are not required to be utilized in connection with the media controlling software application. These password managers can also store, generate, and manage their passwords for local applications and online services, and can include: passwords to other locally installed software applications, online services accessed through website portals, and/or locally accessed hardware devices that serve as keys. According to some embodiments, signing in and/or resetting passwords can require multi-factor (e.g. at least two factors) authentication.

For example, users 104 who have forgotten their password launch a self-service application from an extension to their workstation login prompt, using their own or another user's web browser, or through a telephone call. Users 104 establish their identity, without using their forgotten or disabled password, by answering a series of personal questions, using a hardware authentication token, responding to a notification e-mail or, less often, by providing a biometric sample such as voice recognition. Users 104 can then either specify a new, unlocked password 210, or ask that a randomly generated password 210 be provided.

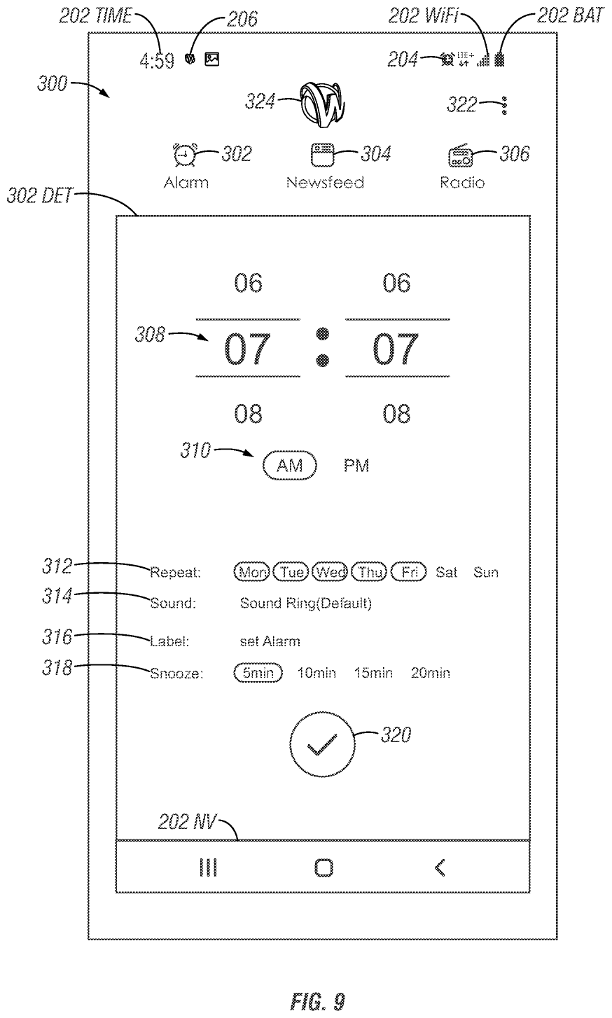

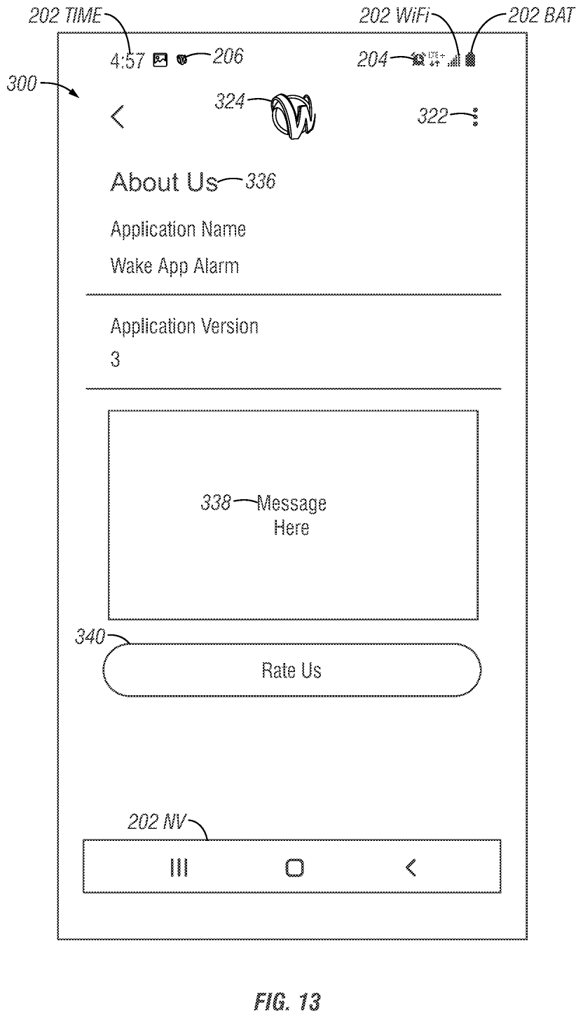

Exemplified aspects of the graphical user interface 148 are shown in the the screenshot of the main navigation pane 300 throughout FIGS. 9-13. As can be seen with FIGS. 9-12, the user 104 is regularly allowed to access through the main navigation pane 300 the alarm clock module 132 and/or sleep module 134 by way of an alarm widget 302 and the media module 136 by way of a newsfeed widget 304 and radio widget 306. As suggested by FIG. 13, The main navigation pane 300 can predominantly rely on only a back button if only minor aspects of the software application are being displayed. In some embodiments, navigation panes, and/or on some screens (e.g. 300), the user 104 shall have the ability to access a user selectable settings page 322 and/or return to a home page by hitting a home button 324.

The settings page 322 in particular can control aspects such as zoom, brightness, volume, options to customize a layout, options to take a screenshot, historical records (e.g. songs played, stations played, browsing history, news stories viewed, etc.), favorites/bookmarks related databases, downloads, casting options (e.g., when the device is capable of controlling other media devices in close proximity), and/or any other typical options one can find in the settings page of a web browser.

FIG. 9, in particular, shows details 302DET of the alarm widget 302, which includes a time selector 308, AM/PM toggle 310, daily selector 312, sound selector 314, label selector 316, default snooze selector 318, save button 320.

The time selector 308 can be a scroll wheel, slider, box that allows a manual type entry (e.g., via keyboard and/or keyboard widget, popup calendar, and any other suitable means for picking a time of day. An AM/PM toggle 310 can be included where its inclusion will be more convenient for the user 104 (e.g. the user 104 is more accustomed to contextualizing their day based on the twelve hour clock rather than a twenty four hour clock). The daily selector 312, likewise, can comprise a scroll wheel, slider, box that allows a manual type entry (e.g., via keyboard and/or keyboard widget, popup calendar, and any other suitable means for picking a date, and in particular, day(s) of a week. In essence, the time selector 308 and daily selector 312 allow the user 104 to pick dates and times for alarms and other times to play media accessible through the software app. Together they form the portion of the graphical user interface widget, e.g., alarm widget 302, that allows the user to select a date from a calendar and/or time from a time range. The daily selector 312 provide several advantages, including: (a) allowing the user to enter a date by merely clicking on a date in the pop-up calendar as opposed to having to access a keyboard widget and/or take their hand off a mouse to type in a date; (b) validation of dates by restricting date ranges (e.g., only after today and for two weeks later, or only for dates in the past); (c) a date range can be entered such that for a set of “from-to” date fields, if the “from” field is filled, the “to” field cannot be set to a date before the “from” field, or if the “to” field is filled, the “from” field cannot be set to a later date than the “to” field; (d) can allow for selection of only an alarm for “today”; (e) can customize the day the week begins on (e.g., the most common examples of which are the week beginning on Sunday or Monday); (0 only legal dates can be entered, e.g. leap days in non-leap years cannot be accepted, nor could “February 30” be selected; (g) date format confusion is eliminated amongst countries using different customs and a more “universal” standard is applied. Likewise, in the case of the time selector 308, many similar functions are available, such as (a) ensuring the user cannot enter an invalid time, e.g., twenty fifth (25^{th}) hour of the day or sixty first (61^{st}) minute of an hour; (b) cannot select an out of range time for a specific application, e.g., outside of business hours, during breaks such as lunch, and the like; (c) cannot select an invalid range, such as where alarms correspond to appointments and it is desirable that they only be scheduled to the nearest five (5), ten (10), fifteen (15), or thirty (30), minute increment.

As mentioned above, a separate settings page 322 may control aspects of and/or a master control for volume of sound, however it is to be appreciated that the alarm widget 302 can also allow for controlling aspects of the sound produced by the alarm, including volume, selection of the chime used for the alarm 314, and the like. The alarm widget works to act as a digital alarm clocks but can also make other noises. While simple battery-powered alarm clocks make a loud buzzing or beeping sound to wake a sleeper, it is to be appreciated the sound selector 314 can allow the alarm to be speech, laughing, singing, or playing any other sounds capable of being played by the phone (e.g. sounds emulating noises created by nature). Mobile phones, in particular, can feature the ability for the user to set the alarm's ringtone, and in some cases music can be downloaded to the phone and then chosen to play for waking. Specific alarms selected can be given a customized name by way of the label selector 316. The default snooze selector 316 can also determine the time interval of using the snooze feature of the alarm widget 302. According to some embodiments, aspects of such customization can be saved by the user 104 if the user 104 taps a confirmation or “save” button 320, and popup warnings can be presented to the user 104 where the user 104 tries to exit the app without first saving any changes to any one or more customized alarms.

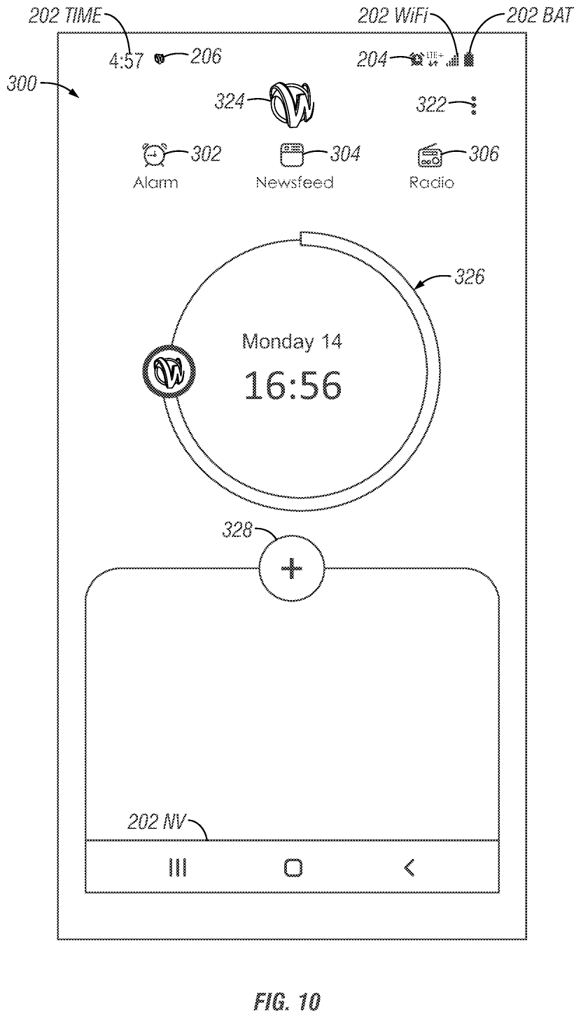

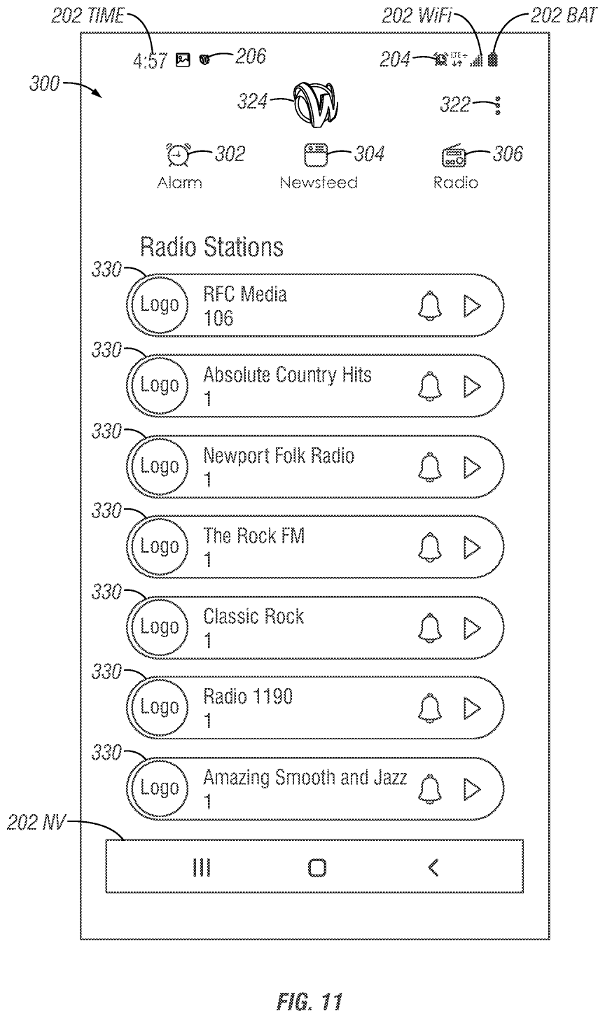

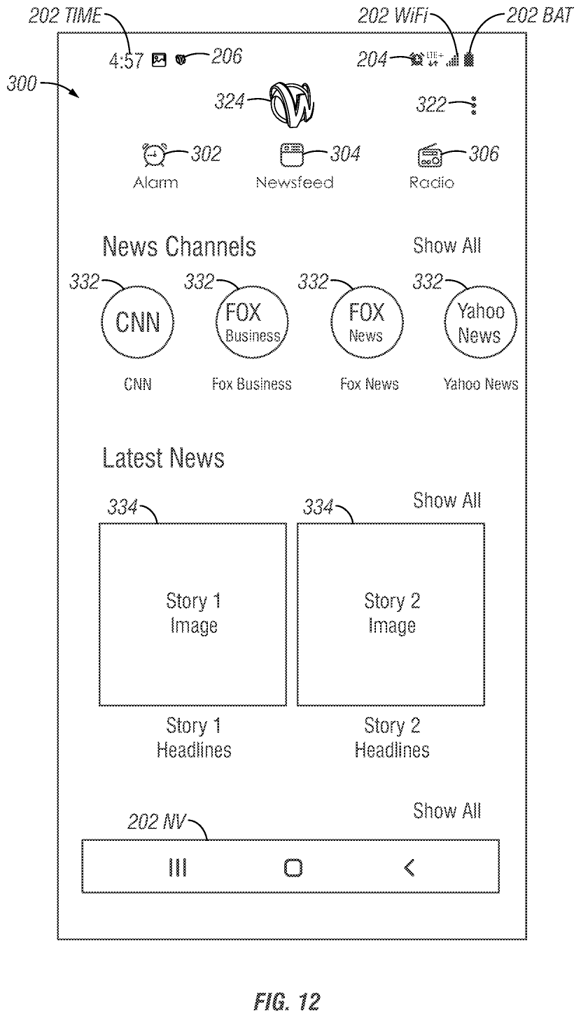

FIG. 10, in particular, shows a default clock widget 326 that can be displayed while details 302DET of specific alarms do not need to be shown. Moreover, a list of the alarms and/or names or labels associated with same (e.g., those customized alarms that are created with details 302DET) can be listed in an alarm organizer 328. FIGS. 11-12, in particular, show aspects of the radio widget 306 and the news widget 304, respectively. The radio widget 306 includes at least the ability to display and select from a list of radio stations 330. Likewise, the news widget 304 includes at least the ability to display and select from a list of news channels 332 and news stories 334.

Finally, the ability to provide the user 104 with information about the provider and/or the ability to provide the provider with some feedback from the user 104 may be desirable to the provider, though these aspects are not required by any means. In such embodiments, these aspects can be located on separate pages or a unified page and can include an about us section 336, a message section 338, and a rate us section 340, as shown in FIG. 13. Both the message section 338 and rate us section 340 exist so as to better give the provider a sense of how to satisfy user needs.

The about us section 336 can be used by the provider to give the user 104 more insight into who is involved with a given business and exactly what it does. The about us section 336 can incorporate contact or locational information. The about us section 336 can also incorporate a history of a business and the histories of the people in charge. People in charge, both present and past, can be accompanied by photographs of said persons. Depending on the provider, some information about goals, attitude or other aspects of culture that are not strictly tied to business practices can be included as well. The about us section 336 can be a reflection of the purpose and personality of the provider and its owners or top employees. Ideally, the about us section 336 will also act a marketing tool for a business, enticing potential customers with both the history and the aspirations of a business, as well as adding a human element, though these aspects are not required. Additionally, about us sections 336 are incorporated into search-engine marketing efforts as a way to find potential users 104 through web searches where the software application is logged in an app store and/or by a search engine. Because ecommerce is a rapidly expanding segment of overall commerce, with more stores being opened each and every day, the about us section 336 should help the provider distinguish itself from the competition.

From the foregoing, it can be seen that the present invention accomplishes at least all of the stated objectives.

### LIST OF REFERENCE CHARACTERS

The following reference characters and descriptors are not exhaustive, nor limiting, and include reasonable equivalents. If possible, elements identified by a reference character below and/or those elements which are near ubiquitous within the art can replace or supplement any element identified by another reference character.

| | |
|---|---|
| 100 | alarm clock system |
| 102 | alarm clock |
| 104 | user |
| 106 | sensor(s) |
| 108 | non-transitory computer readable media capable |
| | of communicating with other media device(s) |
| 110 | database(s) |
| 112 | alarm/sleep data |
| 114 | user/account information |
| 116 | advertising/financial data |
| 118 | news/traffic data |
| 120 | memory |
| 122 | central processing unit |
| 124 | operating system |
| 126 | compiler |
| 128 | communications module |
| 130 | network |
| 132 | alarm clock module |
| 134 | sleep module |
| 136 | media module |
| 138 | user interface module |
| 140 | user interface |
| 142 | speakers |
| 144 | audio notification |
| 146 | display |
| 148 | graphical user interface |
| 150 | visual notification |
| 152 | input(s) |
| 154 | virtual assistant |
| 156 | natural language user interface |
| 158 | designation module |
| 160 | clock module |
| 162 | calendar module |
| 164 | set function/step |
| 166 | begin alarm function/step |
| 168 | sleep or snooze function/step |
| 170 | communicate or engage function/step |
| 172 | perform function/step |
| 174 | skip, loop, or adjust function/step |
| 176 | designate function/step |
| 178 | monitor function/step |
| 180 | store function/step |
| 182 | interface (with alarm) function/step |
| 184 | interface (with media) function/step |
| 186 | recommend function/step |
| 188 | news |
| 190 | entertainment |
| 192 | weather |
| 194 | traffic |
| 196 | calendar |
| 198 | advertisement |
| 200 | mobile phone screenshot for sign-in screen |
| 202 | indicators and functions |
| 202BAT | battery indicator |
| 202TIME | native clock |
| 202Wi-Fi | wireless connectivity indicator |
| 202NV | navigation features |
| 204 | alarm indicator |
| 206 | logo, alternative indicator |
| 208 | slogan |
| 210 | password/PIN |
| 210RS | reset password |
| 212 | username |
| 214 | sign in button |
| 216 | button to register/create new account |
| 300 | main alarm clock navigation pane |
| 302 | alarm widget |
| 302DET | detailed options for alarm widget |
| 304 | news widget |
| 306 | radio widget |
| 308 | time selector (scroll wheels, sliders, manual |
| | type entries, etc.) |
| 310 | AM/PM toggle |
| 312 | daily selector |
| 314 | sound selector |
| 316 | label selector |
| 318 | default snooze selector |
| 320 | save button |
| 322 | setting button |
| 324 | home button |
| 326 | clock widget |
| 328 | alarm organizer |
| 330 | radio stations |
| 332 | news channels |
| 334 | news stories |
| 336 | about us section |
| 338 | message section |
| 340 | rate us section |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, and other computing devices.

“Multi-factor authentication” is an electronic authentication method in which a user is granted access to a website or application only after successfully presenting two or more pieces of evidence (or factors) to an authentication mechanism: knowledge (something only the user knows), possession (something only the user has), and inherence (something only the user is). Multi-factor authentication protects the user from an unknown person trying to access their data such as personal ID details or financial assets.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The “scope” of the present invention is defined by the appended claims, along with the full scope of equivalents to which such claims are entitled. The scope of the invention is further qualified as including any possible combination of any of the aspects of any of the embodiments disclosed to result in additional embodiments, combinations, subcombinations, or the like that would be obvious to those skilled in the art.

What is claimed is:

1. A computer implemented method for engaging media with a time based alarm comprising:
connecting the time based alarm to a network;
upon turning off or snoozing the time based alarm, automatically engaging media with the time based alarm by communicating with at least one non-transitory computer readable medium also connected to the network; and
subsequently performing a task with the non-transitory computer readable medium.

2. The computer implemented method of claim 1 wherein the time based alarm is tangibly embodied within an alarm clock.

3. The computer implemented method of claim 1 wherein the time based alarm is tangibly embodied within a media controlling device selected from the group comprising:
a. a mobile phone;
b. a tablet;
c. a laptop or desktop computer;
d. a television;
e. a gaming console; and
f. a household appliance.

4. The computer implemented method of claim 1 wherein the task is selected from the group comprising:
a. getting local or global political news;
b. getting financial news;
c. receiving a weather forecast;
d. receiving current or anticipated traffic conditions;
e. viewing or listening to entertainment;
f accessing a planner or a calendar;
g. advertising a good or a service to a user; and
h. any combination thereof.

5. The computer implemented method of claim 1 further comprising setting an alarm in connection with a sequence of media to be played upon the turning off or the snoozing of the time based alarm.

6. The computer implemented method of claim 1 wherein a sequence of media to be played upon the turning off or the snoozing of the time based alarm is determined by how the time based alarm is turned off or snoozed.

7. The computer implemented method of claim 1 further comprising using an audio notification and a visual notification to begin an alarm.

8. The computer implemented method of claim 1 further comprising allowing for a user to skip, loop, or adjust media being played after the turning off or the snoozing of the time based alarm.

9. The computer implemented method of claim 1 further comprising monitoring sleep of a user with one or more sensors.

10. The computer implemented method of claim 9 wherein a time in which the user is woken up or a sequence of media to be played upon the turning off or the snoozing of the time based alarm is determined upon the data collected by the one or more sensors.

11. The computer implemented method of claim 9 further comprising recommending sleep related options to the user based upon the data collected by the one or more sensors.

12. The computer implemented method of claim 1 further comprising tracking time with the time based alarm by:
a. manually inputting a set time and subsequently tracking time elapsed from the set time; or
b. syncing the time with an external clock.

13. The computer implemented method of claim 1 further comprising allowing a user to designate whether the time based alarm, the non-transitory computer readable medium, or another non-transitory computer readable medium acts as the primary controlling device.

14. The computer implemented method of claim 1 further comprising:
storing and encrypting data relating to sleep or wake preferences, personal identifying information, a financial accounting, and media preferences associated with a user on a database; and
allowing the user to view and alter the data.

15. An alarm clock comprising:
one or more means to:
connect to a network;
instruct speakers or a display to begin an alarm;
automatically engage media upon turning off or snoozing the alarm; and
perform a task or instruct a non-transitory computer readable medium to perform a task.

16. The alarm clock of claim 15 further comprising a sensor for sensing at least one characteristic related to a user's sleep.

17. The alarm clock of claim 15 further comprising a central processing unit and a memory with an operating system and a compiler located thereon.

18. The alarm clock of claim 17 further comprising an alarm clock module, a sleep module, and a media module, each module forming part of a software application executable by the central processing unit in connection with the operating system and the compiler.

19. The alarm clock of claim 17 further comprising a user interface having input and output devices for delivering an input to the alarm clock.

20. The alarm clock of claim 15 wherein the alarm clock forms part of:
a. a mobile phone;
b. a tablet;
c. a laptop or desktop computer;
d. a television;
e. a gaming console; or
f. a household appliance.
